(19) United States
(12) Patent Application Publication
(10) Pub. No.: US 2022/0126376 A1
(43) Pub. Date: Apr. 28, 2022

(54) Adjustable Angle Toolholder

(71) Applicant: Kaiser Tool Company Inc., Fort Wayne, IN (US)

(72) Inventors: Kenneth A. KING, Leo, IN (US); Dennis BRIDGES, Kendalville, IN (US)

(21) Appl. No.: 17/508,472

(22) Filed: Oct. 22, 2021

Related U.S. Application Data
(60) Provisional application No. 63/104,205, filed on Oct. 22, 2020.

(51) Int. Cl. B23B 29/04; B23B 29/06; B23B 29/24

(52) U.S. Cl. CPC B23B 29/043; B23B 29/244; B23B 29/06

(57) ABSTRACT

An adjustable angle toolholder comprising a shank and an adjustable head is provided. The shank has a first end and a second end. The first end is adapted to be held in a machine, such as a lathe. The second end includes a fixed plane oriented parallel to a lengthwise direction of the shank. The fixed plane includes an arcuate face at a distal end of the fixed plane. The head has a fixed plane that mates with the fixed plane of the shank. The fixed planes of the shank and head include a pivot hole through which a pivot bolt passes. The pivot bolt allows adjustment of the head through a wide range of angles relative to a lengthwise direction of the shank, while the fixed planes maintain a position of a centerline of a cutting tool constant with respect to a centerline of the shank. The fixed plane of the shank may be on a centerline of the shank.

### BACKGROUND

The art of cutting grooves in a workpiece using a cutting tool, and particularly using an insert secured in a shank, is well known. For example, a small-size insert may be securely held within a head of a shank even when encountering lateral forces which tend to move the insert out of position with respect to the holder. See, for example, U.S. Pat. No. 6,824,333. The inserts are commonly referred to as cutting tools, and the shanks with seats/clamps for mounting cutting tools are referred to as toolholders.

Traditional toolholders have a head at a fixed angle relative to the shank. Typically, the toolholders hold the cutting insert either parallel to or perpendicular to the shank centerline. Holding the cutting insert parallel to the shank centerline is useful for cutting face or axial grooves at the end of a workpiece, and holding the cutting insert perpendicular to the shank is useful for cutting radial grooves on the workpiece. When a workpiece is mounted in a lathe, depending on the geometry of the cutting tool, a rectangular, triangular, rounded, or other shape groove may be cut by the cutting tool as the workpiece is rotated by the lathe and the cutting tool applied to the workpiece.

If a groove or other cut is desired having an angle other that 0 degrees (parallel to the rotational axis of the workpiece for axial grooves) or 90 degrees (perpendicular to the rotational axis of the workpiece for radial grooves), a toolholder with an angled head may be used. For example, it is known to have toolholders with heads having a fixed angle of 30, 45, or 60 degrees with respect to the shank of the toolholder. However, this does not provide flexibility to cut grooves at non-standard angles, and also does not allow for adjustments to change cutting angles.

It is also known to provide for a few degrees of rotation of a cutting tool on an axis parallel to the shank and concentric to the groove to facilitate cutting face grooves of different diameters or to facilitate cutting threads of different pitches. However, such toolholders are not suitable or adaptable for cutting face grooves at variable angles with respect to a rotational axis of a workpiece.

### SUMMARY

An adjustable angle toolholder comprising a shank and an adjustable head is provided. The shank has a first end and a second end. The first end is adapted to be held in a machine, such as a lathe. The second end includes a fixed plane oriented parallel to a lengthwise direction of the shank. The fixed plane includes an arcuate face at a distal end of the fixed plane. The head has a fixed plane that mates with the fixed plane of the shank. The fixed planes of the shank and head include a pivot hole through which a pivot bolt passes. The pivot bolt allows adjustment of the head through a wide range of angles relative to a lengthwise direction of the shank, while the fixed planes maintain a position of a centerline of a cutting tool constant with respect to a centerline of the shank. The fixed plane of the shank may be on a centerline of the shank.

The head may be rotatable continuously from +90 degrees to −90 degrees with respect to a lengthwise direction of the shank. The shank may further comprise an indicator line and the head may further comprises an arcuate portion with a graduated scale to indicate a degree of rotation.

One of the pivot holes may be threaded and the pivot bolt passes through the other pivot hole and threads into the threaded pivot hole. The pivot bolt may comprise a shoulder bolt. The pivot hole of the shank may be perpendicular to and pass through a lengthwise centerline of the shank.

The head may further comprise an integrated seat to locate a cutting tool. The fixed plane of the shank and the fixed plane of the head may be located to place a centerline of a cutting tool on a centerline of the shank.

### BRIEF DESCRIPTION OF THE DRAWINGS

FIG. 1 is a view of an adjustable tool holder according to the present invention with its head rotated to 0° relative to a lengthwise direction of the shank.

FIG. 2 is a view of the adjustable tool holder as adjusted in FIG. 1 cutting a radial groove on a workpiece.

FIG. 3 is a view of the adjustable tool holder of FIG. 1 with its head rotated to +15°.

FIG. 4 is a view of the adjustable tool holder as adjusted in FIG. 3 cutting a radial groove on a workpiece.

FIG. 5 is a view of the adjustable tool holder of FIG. 1 with its head rotated to −35°.

FIG. 6 is a view of the adjustable tool holder as adjusted in FIG. 5 cutting a radial groove on a workpiece.

FIG. 7 is an exploded view of the adjustable tool holder of FIG. 1.

### DETAILED DESCRIPTION

The adjustable angle toolholder 10 allows the user to set the cutting angle of the cutting tool 100 relative to a workpiece axis of rotation for grooving applications. The adjustable angle toolholder 10 comprises a shank 200 and an adjustable head 300. The shank 200 is held by the machine. The adjustable head 300 has a clamp 310 and other features to hold a cutting tool 100.

The shanks 200 may be square, rectangular, round, or round with an indexing flat. Shanks 200 can be in various sizes. In some embodiments, shank 200 sizes may be under 1.5 inches round or square and under 12 inches in length. Shanks 200 will be compatible with various head 300 designs.

The shank 200 has a fixed plane 210 at an end where the adjustable head 300 is mounted. The fixed plane 210 is oriented parallel to a lengthwise direction of the shank 200. An arcuate face 212 is provided at a distal end of the fixed plane 210 and a flat face 214 at an opposite end of the fixed plane 210. The arcuate face 212 is convex and provides clearance for the head 300 to rotate when mated to the fixed plane 210. In some embodiments, the fixed plane 210 is located on a centerline of the shank 200. The shank 200 has a pivot hole 220 through which a pivot bolt 222 may be passed. The dimensions of the pivot hole 220 and pivot bolt 222 are tightly controlled to provide a precision pivot point.

The pivot hole 220 passes through the fixed plane 210, preferably perpendicularly to the fixed plane 210. In some embodiments, the pivot hole 220 is perpendicular to and passes through a centerline of the shank 200. The head 300 has a corresponding fixed plane 302 which mates with the fixed plane 210 of the shank 200. The location of the fixed plane 302 on the head 300 and the location of the fixed plane 210 on the shank 200 determine a centerline position of the cutting tool 100 relative to the shank 200. The fixed planes 210, 302 ensure that this centerline position of the cutting tool 100 does not vary with rotation of the adjustable head 300 relative to the shank 200. In some embodiments, the fixed planes 210, 302 may be located to place the centerline of the cutting tool 100 on the centerline of the shank 200. However, in some applications, that need not be the case.

The shank 200 has a fixed indicator line 230 as a zero reference to assist in positioning the head 300 with respect to the shank 200.

The fixed plane 302 of the head 300 controls the centerline position of the cutting tool 100 and mates with the fixed plane 210 on the shank 200. The head 300 has an arcuate portion 304 formed at one end of the fixed plane 302. The arcuate portion 304 allows the head 300 to rotate relative to a lengthwise axis of the shank 200 about a pivot axis that is perpendicular to the lengthwise axis of the shank 200. In some embodiments, the head 300 is rotatable continuously from +90° to −90° with respect to the lengthwise direction of the shank 200. Other ranges of rotation and non-continuous (e.g., in intervals of 1°) may also be employed. The head 300 has a graduated scale 320 on the arcuate portion which, when compared to the fixed indicator line 230 on the shank 200, indicates the angle of rotation of the head 300 relative to the lengthwise direction of the shank 200.

The head 300 also has a pivot hole 220 extending through the fixed plane 302 on the head 300 and through which the pivot bolt 222 passes. In the illustrated embodiment, the pivot hole 220 on the head 300 is threaded and the pivot bolt 222 threads into the head 300. The components may be oriented such that loads placed on the head 300 while cutting urge the head 300 in a direction to tighten, rather than loosen, the pivot bolt 222. In some embodiments, the pivot bolt 222 comprises a shoulder bolt. The shoulder bolt may have a smooth shank top, or shoulder, with a narrower, threaded tip at the bottom. In such examples, the pivot hole 220 on the shank 200 is also unthreaded, and provides a bearing surface for the shoulder of the pivot bolt 222. In other embodiments, the pivot hole 220 on the shank 200 is threaded and the pivot hole on the head 300 provides a bearing surface for the pivot bolt 222. In some embodiments, the pivot bolt 222 includes flats or an Allen socket for receiving a wrench when tightening the pivot bolt 222.

The head 300 has an integrated seat 330 to locate and orient the cutting tool 100. The seat 330 may be oriented parallel, perpendicular or at intermediate angles to the graduated scale 320. The seat 330 will be compatible with various cutting tools, and may have features as described and illustrated in U.S. Pat. Nos. 6,974,282 and 6,824,333, which are incorporated by reference. The seat 330 has an angled surface to prevent rotation and lateral movement of the cutting tool 100. The seat 330 has a stop 332 to prevent the cutting tool 100 from pushing away from the work piece.

The head 300 has a clamp 310 to secure the cutting tool 100 in the seat 330 and prevent movement. The clamp 310 is located with a fulcrum 312 and held with a screw 314. The clamp 310 has an angled surface to prevent rotation and lateral movement of the cutting tool 100. See, for example, U.S. Pat. No. 3,296,683, which is incorporated by reference.

In use, to adjust the angle, a user loosens the pivot bolt 222, aligns the fixed indicator line 230 of the shank 200 to the desired position on the graduated scale 320 of the head 300 then tightens the pivot bolt 222. The seat 330 for the cutting tool 100 transfers the cutting forces from the cutting tool 100 to the head 300. The fixed planes 210 transfer the cutting forces from the head 300 to the shank 200. The shank 200 transfers the cutting forces into the machine.

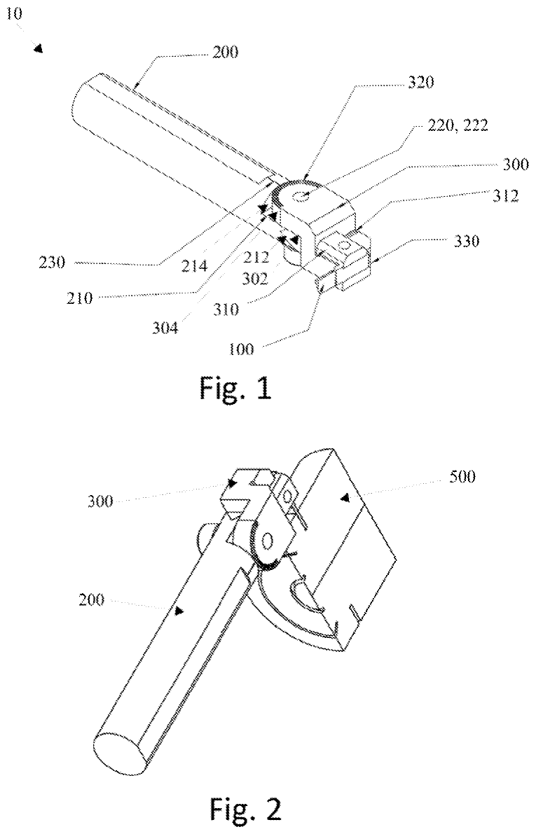

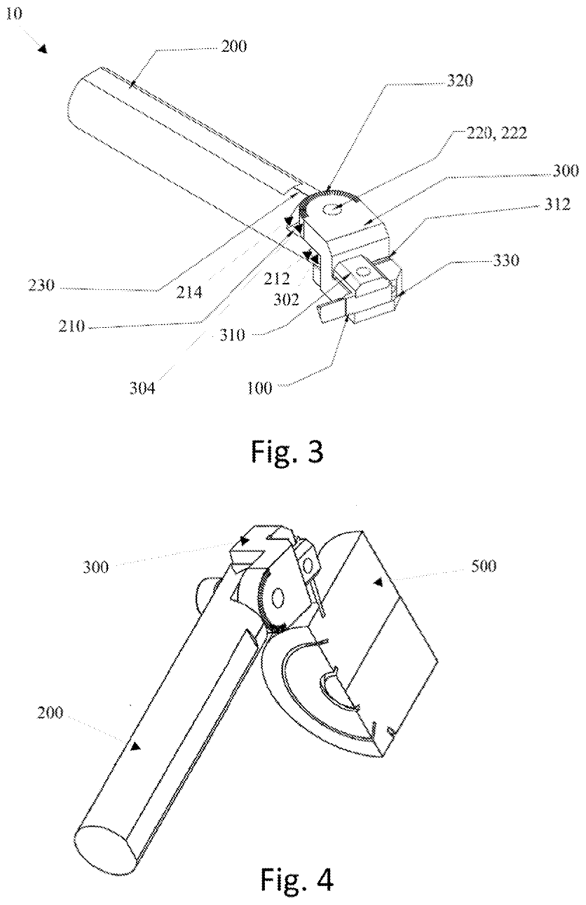

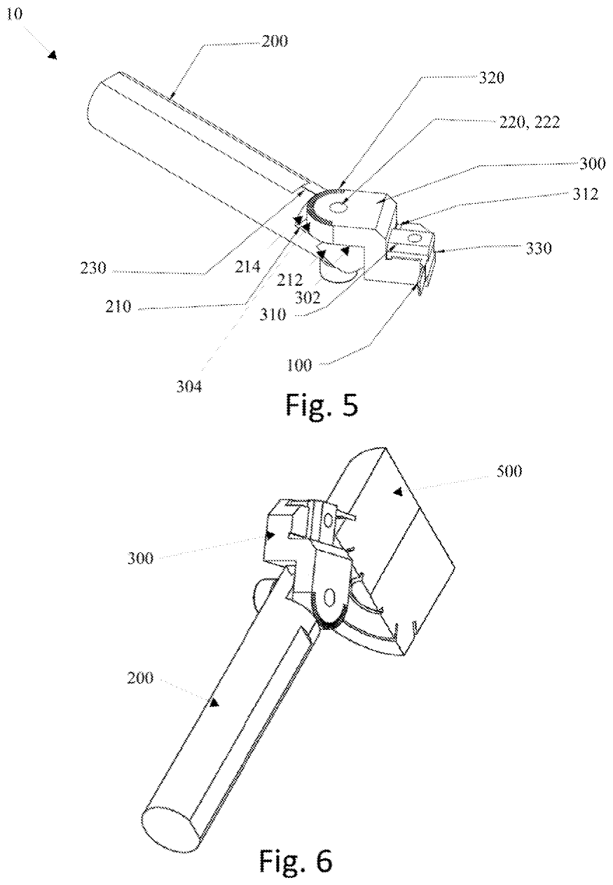

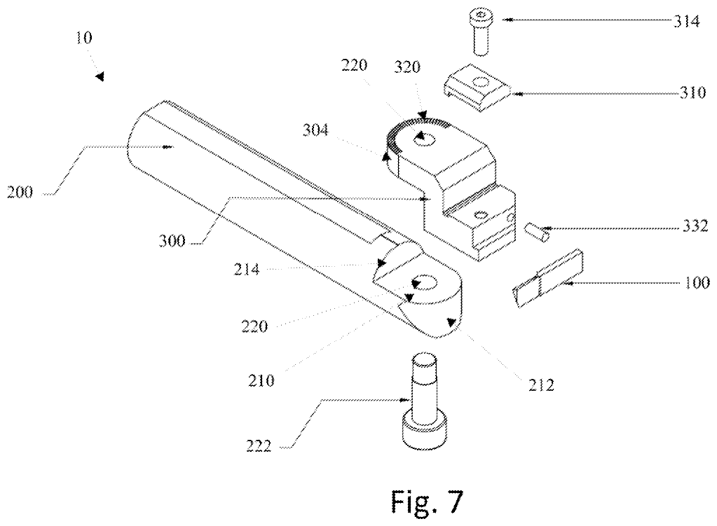

For example, in FIGS. 1 and 2, the head 300 is adjusted so that the head 300 is at zero degrees of rotation relative to an axial direction of the shank 200. With the head 300 holding the cutting tool 100 at 90 degrees relative to the lengthwise axis of the shank 200, a radial groove is cut on the workpiece 500 at 90 degrees to the axial direction of the workpiece 500. In FIGS. 3 and 4, the head 300 is adjusted to 15 degrees and the radial groove is cut at 105 degrees (90°+15°) from the axial direction of the workpiece 500. In FIGS. 5 and 6, the head 300 is adjusted to −35 degrees and the radial groove is cut at 55 degrees (90°−35°) from the axial direction of the workpiece 500. As is illustrated in FIGS. 2, 4, and 6, adjustable angle axial (face) grooves may also be cut by the adjustable angle toolholder 10.

From the foregoing, it will be understood that numerous modifications and variations can be effectuated without departing from the true spirit and scope of the novel concepts of the present invention. It is to be understood that no limitation with respect to the specific embodiments illustrated and described is intended or should be inferred.

What is claimed is:

1. An adjustable angle toolholder, comprising:
a shank having a first end and being adapted to be held in a machine and a second end including a fixed plane oriented parallel to a lengthwise direction of the shank and an arcuate face at a distal end of the fixed plane; and
an adjustable head having a plane that mates with the fixed plane of the shank;
a first pivot hole through the fixed plane of the shank;
a second pivot hole through the fixed planes of the head; and
a pivot bolt passing through the first and second pivot holes;
wherein the pivot bolt allows adjustment of the head through a wide range of angles relative to a lengthwise direction of the shank, while the fixed planes of the shank and the head maintain a position of a centerline of a cutting tool constant with respect to a centerline of the shank.

2. The toolholder of claim 1, wherein the fixed plane of the shank is on a centerline of the shank.

3. The toolholder of claim 1, wherein the shank further comprises an indicator line and the head further comprises an arcuate portion with a graduated scale.

4. The toolholder of claim 1, wherein the head is rotatable continuously from +90 degrees to −90 degrees with respect to a lengthwise direction of the shank.

5. The toolholder of claim 1, wherein the second pivot hole is threaded and the pivot bolt passes through the first pivot hole and threads into the second pivot hole.

6. The toolholder of claim 5, wherein the pivot bolt comprises a shoulder bolt.

7. The toolholder of claim 1, wherein the first pivot hole is perpendicular to and passes through a lengthwise centerline of the shank.

8. The toolholder of claim 1, wherein the head further comprises an integrated seat to locate a cutting tool.

9. The toolholder of claim 1, wherein the fixed plane of the shank and the fixed plane of the head are located to place a centerline of a cutting tool on a centerline of the shank.
